(19) United States
(12) Patent Application Publication
(10) Pub. No.: US 2018/0304542 A1
(43) Pub. Date: Oct. 25, 2018

(54) Composite Component for a Vehicle, in Particular a Motor Vehicle, and Method for the Production of a Composite Component

(71) Applicant: DAIMLER AG, Stuttgart (DE)

(72) Inventor: Tobias BLUMENSTOCK, Stuttgart (DE)

(73) Assignee: Daimler AG, Stuttgart (DE)

(21) Appl. No.: 15/738,045

(22) PCT Filed: May 12, 2016
(86) PCT No.: PCT/EP2016/000786

§ 371 Date: Dec. 19, 2017

(30) Foreign Application Priority Data
Jun. 20, 2015 (DE) 102015007921.2

(51) Int. Cl. B29C 65/06; B32B 27/06; B32B 5/18; B32B 7/04; B32B 7/02; B32B 27/12; B32B 27/36; B32B 27/32; B29C 65/00

(52) U.S. Cl. CPC B29C 65/06; B29L 2031/3041; B32B 5/18; B32B 7/04; B32B 7/02; B32B 27/12; B32B 27/36; B32B 27/32; B29C 66/721; B29C 66/727; B29C 66/73132; B29C 66/73116; B32B 2266/0264; B32B 2307/72; B32B 2605/003; B32B 27/065

(57) ABSTRACT

A composite component for a vehicle has a core layer made from a theiinoplastic plastic foam and at least one cover layer which is connected to the core layer. The core layer has a higher density in one region than the density of the semi-finished core layer. The cover layer formed from a fiber-reinforced plastic is connected in the region of higher density to at least one joining element by friction welding.

### BACKGROUND AND SUMMARY OF THE INVENTION

The invention relates to a composite component for a vehicle, in particular a motor vehicle, and a method for the production of a composite component.

Such a composite component for a vehicle, in particular a motor vehicle, and a method for the production of a composite component can, for example, already be gleaned as known from DE 10 2006 058 257 A1. The composite component has a core layer which is formed from a thermoplastic plastic foam. In other words, the core layer is formed as a foam element which is produced from a plastic in the form of a thermoplastic. The composite component furthermore has a cover layer which is connected to the core layer. This means that the cover layer is arranged on the core layer, wherein the cover layer and the core layer at least partially overlap each other. Furthermore, the core layer and the cover layer are pressed together.

In the scope of the method for the production of the composite component, the cover layer is connected to the plastic foam, wherein the core layer and the cover layer are introduced into a pressing tool and pressed together by means of the pressing tool. As a result, the cover layer and the core layer form a layer composite of the composite component. It is thus possible to form the composite component as a sandwich composite component, wherein at least one additional cover layer can be arranged on a side of the core layer which faces away from the cover layer and can be connected to the core layer, in particular pressed.

Furthermore, DE 20 2011 005 422 U1 discloses a plastic body made of several individual parts joined with a sandwich construction, the individual parts being at least partially connected to one another in a positive-, force- and/or material-locking manner by means of several different joining techniques and assembled to form a compact vehicle body. In this case, at least some of the supporting individual parts consist of carbon fiber-reinforced plastic, and cavities between the individual parts are at least partially filled with foam material. Furthermore, provision is made for the individual parts to be prefabricated in shell construction during the pyrolysis procedure and for the plastic to be mechanically processed after impregnation at individual suitable locations.

The object of the present invention is to create a composite component and a method of the type cited above, by means of which a particularly cost-effective production of the vehicle can be achieved.

In order to create a composite component of the type cited above, by means of which a particularly cost-effective production of the vehicle can be achieved, provision is initially made according to the invention for the composite component to contain a core layer made from a thermoplastic plastic foam and at least one cover layer connected to the core layer. The core layer furthermore has a higher density in one region than the density of the semi-finished core layer. In other words, the core layer is formed from a thermoplastic initial foam material, the semi-finished core layer. The cover layer formed from a fiber-reinforced plastic is connected in the region of higher density to at least one joining element by means of friction welding. The invention is based on the knowledge that joining methods for connecting a composite component, in particular the cover layer thereof, to at least one joining element are usually limited to adhesive bonding or screwing, since this means that damage to the composite component, in particular the core layer, as well as undesired marks on at least one surface of the composite component can be avoided. However, adhesive bonding and screwing are expensive and time consuming, in particular because of the equipment required or the need to use separate connecting elements. In contrast, a connection to be established between the cover layer and the joining element can be achieved in a particularly cost- and time-effective manner by using friction welding. The structure and the higher density make it possible for friction welding to be carried out in a time- and cost-effective manner since undesired damage and marks on surfaces of the composite component can be safely avoided.

In one preferred embodiment of the invention, the core layer has a higher density in at least one first partial region than in at least one second partial region which is adjacent to the first partial region and therefore has local compressions which are generated in a targeted manner. The higher density in the first partial region than the second partial region is achieved, for example, by the composite component being pressed more strongly in the first partial region than in the second partial region which is adjacent to the first partial region. Damage to the composite component can be avoided by the locally limited, stronger pressing during the production of the composite component, since the density of the core layer formed as a foam core is increased locally, which results in an increase in the mechanical pressure properties or compressive strength of the core layer, i.e., the thermoplastic plastic foam, with respect to the less strongly pressed second partial region. The layers, in particular the core layer, of the composite component are usually sensitive to very high pressures and temperatures, which, however, can now be avoided by the locally higher density, in particular by the locally stronger pressing. However, since the composite component only has a higher density locally or is only pressed more strongly locally, the material character of the composite component remains preserved when observed over the entire composite component. In other words, it is possible to achieve a damage-free connection between the composite component and the joining element in a simple manner by means of the locally higher density. As a result of the locally higher density, the core layer also withstands very high pressures, as are common during friction welding, such that a connection is enabled in a simple manner and at a very variable location without any damage occurring.

Due to the locally stronger pressing of the composite component, it can be produced without additional material, cost or time requirements and can thus be formed to be appropriate for the load, since the compressive rigidity and compressive strength can be increased locally. In other words, it is possible to toughen up the first partial region or respective partial regions in which the composite component is pressed more strongly than in other partial regions, and thereby adapt to locally occurring high loads such as those which may occur during friction welding. It is thus possible to avoid an impression and collapse of the composite component representing a sandwich composite, for example, as a result of external influences, i.e., during friction welding. Furthermore, it is possible to achieve a particularly high surface quality of the composite component, since impairments of the surface can be avoided.

In one alternative embodiment, the core layer is formed before the friction welding process by pressing over the entire surface with a higher density than the density of the semi-finished core layer, i.e., than the density in the original state of the core layer. After this, the friction welding is carried out as described. This embodiment is therefore particularly advantageous when a composite component is desired which should have pressure-resistant properties on all sides, even outside the joints. In this context, it is also conceivable to design partial surfaces of the semi-finished core layer to be pressure-resistant and which should have no joints.

One embodiment is characterized in that the joining element is formed from a plastic. During friction welding, the plastic of the joining element and/or the plastic of the cover layer are melted, whereby the joining element is firmly connected to the cover layer and thus the composite component as a whole.

It has also been shown to be particularly advantageous for the plastic of the cover layer to be a thermoplastic. The thermoplastic of the cover layer is a matrix or a plastic matrix and in particular a thermoplastic plastic matrix, into which reinforcing fibers are at least partially embedded. These reinforcing fibers are preferably glass fibers and/or natural fibers and/or carbon fibers and/or aramid fibers in order to thereby provide, for example, a particularly advantageous rigidity of the cover layer and thus of the composite component as a whole. In particular, this makes it possible to achieve particularly advantageous mechanical properties of the composite component. This embodiment is further based on the knowledge that the core layer can be particularly well protected by the thermoplastic formation of the cover layer, such that undesired impairments of the composite component caused by friction welding can be safely avoided.

Due to the thermoplastic formation, the material of both the cover layer and the joining element can be readily melted, whereby they can be firmly connected to each other in a material-locking manner without damaging the core layer. Friction welding can be carried out, for example, by means of a pin to be pressed onto the two joining members and/or through the joining element itself. Furthermore, it has been shown that, when using thermoplastic materials, a certain wall thickness, in particular minimum wall thickness, is advantageous in order to avoid undesired marks on a surface, in particular on a visible side, of the composite component. The visible side is to be understood to be a side or a surface of the composite component which, in the finished manufactured state of the vehicle, is visually perceptible to viewers of the vehicle, in particular to passengers in the interior space of the vehicle. Marks are understood to be undesired visual impairments to the visible side, which can be avoided with the composite component according to the invention while at the same time as the possibility of connecting the cover layer to the joining element by means of friction welding being achieved.

One particularly advantageous embodiment is characterized in that the thermoplastic of the cover layer is polypropylene (PP). The cover layer is, for example, a non-woven fabric or formed from a non-woven material and may, in particular, be formed from a hybrid non-woven material. Furthermore, it is conceivable for the cover layer to be formed from an organic sheet or a hybrid fabric.

In one particularly advantageous embodiment of the invention, the thermoplastic plastic foam of the core layer is formed from polyethylene terephthalate (PET). In other words, the core layer is preferably a PET foam core whose density and thus mechanical pressure properties can be increased locally in a particularly advantageous manner, in particular by locally stronger pressing.

The bonding of the cover layer to the core layer can take place by means of at least one melt layer arranged between the core layer and the cover layer or by means of a reactive adhesive, by means of which a layer is formed which is different from the cover layer and core layer and is provided in addition to this. The above-mentioned melt layer is formed, for example, by the melted plastic of the cover layer.

In order to create a method of the type cited above, by means of which a particularly cost-effective production of the vehicle can be achieved, provision is made according to the invention for the cover layer formed from a fiber-reinforced plastic to be connected to at least one joining element by means of friction welding. Advantageous embodiments of the composite component according to the invention are to be considered as advantageous embodiments of the method according to the invention and vice versa.

In order to avoid undesired damage and/or markings on a surface of the composite component caused by friction welding, provision is made in one embodiment of the invention for the core layer to be formed with a higher density in at least one first partial region than in at least one second partial region which is adjacent to the first partial region, wherein the cover layer is connected in the first partial region to the joining element by means of friction welding.

Provision is preferably made for the composite component to be pressed more strongly in the first partial region than in the second partial region, wherein after pressing, the cover layer is connected in the first partial region to the joining element by means of friction welding. It has been found that the cover layer, which is very thin and has a surface weight of 100 to 500 grams per square meter, for example, may not be able to protect the sensitive core layer, which has a density of between 50 and 200 kilograms per cubic meter, for example, under normal parameters of the friction welding process, since the core layer could collapse under the normal force used during friction welding or the joint would stand out due to the high welding pressure on the visible side of the composite component. Such markings and damage to the composite component can now be avoided even when using a very thin cover layer, since the composite component has a higher density locally, i.e., has a higher density in the first partial region than in the second partial region. As an alternative or in addition to the locally higher density, the composite component can be connected to the joining element, which is preferably made from a plastic, by means of friction welding by increasing the welding amplitude and/or the welding frequency, since the normal force acting on the composite component during friction welding and thus the risk of the core layer collapsing can then be kept particularly low.

Here, it has been shown to be particularly advantageous when friction welding is carried out with a welding amplitude of 1 millimeter. A further embodiment is characterized in that the core layer has a temperature during pressing which at least virtually corresponds to the processing temperature of the plastic of the cover layer. As a result, the core layer can be compressed without cell walls of the core layer breaking or melting. Here, it has been shown to be particularly advantageous when the temperature is in a range from 160 degrees Celsius to 250 degrees Celsius.

A thermoplastic is preferably used as the plastic of the cover layer, which may be polypropylene (PP) in particular. Furthermore, it has been found to be particularly advantageous when the thermoplastic plastic foam is formed from polyethylene terephthalate (PET), such that the core layer is formed as a PET foam core. PET has a softened state at temperatures above 140° C. and can thus be plastically deformed. Only when reaching the melting point above 250° C. does PET start to melt, whereas PP melts at 160° C. This combination of materials is thus particularly advantageous since, between 160° C. and 250° C., the thermoplastic of the cover layer is melted and the core can be plastically deformed without the foam structure being destroyed. This means that a wide temperature range can be used for the manufacturing process. In addition, the process reliability during welding is increased if the melting temperature of the core is substantially higher than the melting temperature of the cover layer.

In addition or as an alternative to the pressing of the core layer which is stronger in the first partial region than in the second partial region, provision can be made for the core layer to be produced by means of an extrusion method, wherein the locally higher density in the first partial region is adjusted by varying the extrusion profile of the core layer during its production, for example. It is also conceivable to partially separate one part from the core layer, i.e., in the first partial region, in particular to cut it out, as a result of which a recess or a gap in the first partial region is formed. A foam body is then inserted into the recess, i.e., into the first partial region, the foam body having a higher density than the rest of the core layer, i.e., than the second partial region which is adjacent to the foam body.

Further advantages, features and details of the invention arise from the following description of preferred exemplary embodiments as well as with the aid of the drawings.

### BRIEF DESCRIPTION OF THE DRAWINGS

FIG. 1 is a schematic sectional view through a composite component for a vehicle, having a core layer made from a thermoplastic plastic foam and at least one cover layer connected to the core layer, wherein the core layer has a higher density in at least one first partial region than in at least one second partial region which is adjacent to the first partial region and wherein the cover layer formed from a fiber-reinforced plastic is connected to at least one joining element in the first partial region by friction welding; and

FIG. 2 is a further schematic sectional view through the composite component which is connected to respective joining elements by means of friction welding.

### DETAILED DESCRIPTION OF THE DRAWINGS

In the figures, the same or functionally identical elements are provided with the same reference numerals.

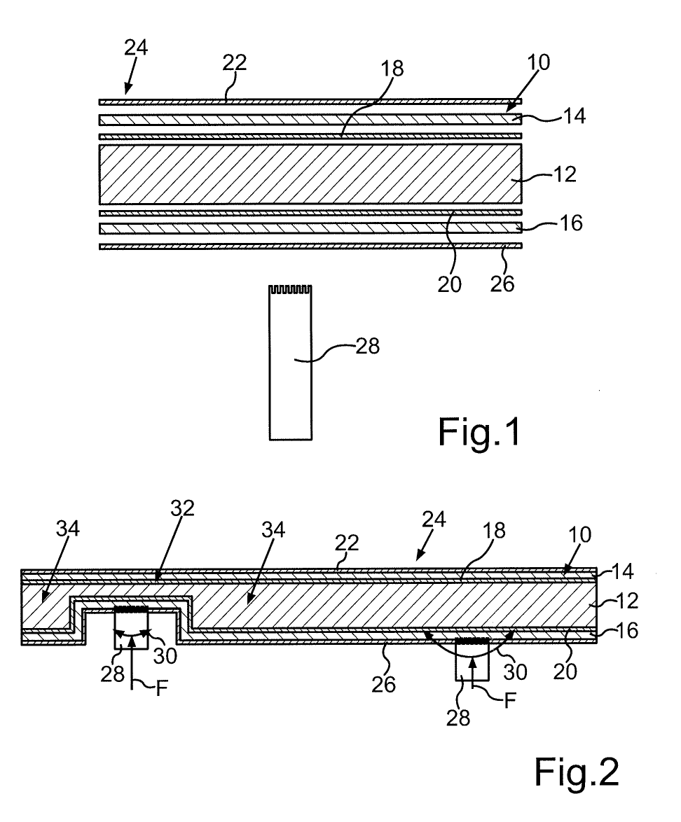

FIG. 1 is a schematic sectional view of a composite component in the form of a sandwich composite component which is produced from a layer composite referred to with 10. The layer composite 10 and thus the composite component comprise a core layer 12 made from a thermoplastic plastic foam. The core layer 12 is preferably made from polyethylene terephthalate (PET) and is thus formed as a PET foam core. The layer composite 10 furthermore comprises respective cover layers 14 and 16 between which the core layer 12 is arranged. The respective cover layer 14 or 16 is formed from a fiber-reinforced plastic, wherein the plastic of the cover layer 14 or 16 is preferably a thermoplastic and in particular polypropylene (PP). The plastic of the respective cover layer 14 or 16 is thus a matrix or a matrix material into which reinforcing fibers are embedded. These reinforcing fibers are preferably glass fibers, natural fibers, aramid fibers and/or carbon fibers. The respective cover layer 14 or 16 can, for example, be formed from a hybrid non-woven material, organic sheet or hybrid woven fabric.

At least one bonding layer 18 or 20 is arranged between the respective cover layer 14 or 16 and the core layer 12, via which bonding layer the respective cover layer 14 or 16 is connected to the core layer 12. The respective bonding layer 18 or 20 is also referred to as a melt layer since it is liquefied or melted, for example, during the production of the composite component or of the layer composite 10. The respective bonding layer 18 or 20 is formed, for example, by the plastic of the respective cover layer 14 or 16 or by an additionally provided plastic or from an adhesive, in particular reactive adhesive, which is provided in addition to the respective plastic of the cover layers 14 and 16 and the core layer 12. The connection of the cover layers 14 and 16 to the core layer 12 takes place via the respective bonding layer 18.

Overall, it can be seen from FIG. 1 that a sandwich composite having a thermoplastic foam core and fiber-reinforced thermoplastic cover layers 14 and 16 is formed by the layer composite 10. For example, a panelling part, in particular interior panelling part, of a vehicle such as a motor vehicle and in particular a passenger vehicle, for example, is produced from the layer composite 10.

The composite layer 10 is introduced, for example, as a semi-finished product into a pressing tool which comprises two tool halves. The tool halves are, for example, arranged opposite each other and can be moved towards each other and away from each other. If the layer composite 10 (semi-finished product) is located, for example, between the tool halves, these are moved towards each other, i.e., closed, as a result of which the layer composite 10 is pressed, for example. The composite component is thus a press component which is pressed by means of the pressing tool and is formed at the same time or subsequently by means of a forming tool.

The layer composite 10 can optionally comprise a decorative layer 22 which is arranged on the cover layer 14 and is connected to the cover layer 14, for example. The decorative layer 22 is arranged on a visible side 24 of the composite component. Such a visible side is to be understood to be a side which, in the finished manufactured state of the vehicle, is visually perceptible to viewers of this vehicle, in particular to passengers in the interior space of the vehicle. The decorative layer 22 can thus provide an advantageous visual impression of the composite component as a whole. Alternatively or additionally, the layer composite 10 may have a textile layer 26 which is arranged on a side of the cover layer 16 which faces away from the visible side 24 or the decorative layer 22, the textile layer 26 being connected, for example, to the cover layer 16. The textile layer 26 is formed from polyester, for example.

In FIG. 1, a joining element 28 is also shown which is formed, for example, from a plastic. As will be described in more detail below, the joining element 28 is connected by means of friction welding to one of the cover layers 14 and 16 and in the present case to the cover layer 16, such that the joining element 28 is a plastic welded part. In other words, the joining element 28 is welded onto the layer composite 10 without this resulting in undesired damage to the layer composite 10.

During friction welding, the joining element 28 is pressed onto the layer composite 10, in particular the cover layer 16, and is caused to vibrate, as a result of which energy is supplied. The amount of energy supplied must be high enough for the plastic of the joining element 28 and optionally the plastic of the cover layer 16 to melt and for the joining element 28 to be connected to the layer composite 10, i.e., the cover layer 16, at a contact surface. The amount of energy supplied is made up of a normal force with which the joining element 28 is pressed against the layer composite 10 during friction welding, and the frequency and amplitude of the vibration. The amplitude is also referred to as welding amplitude, wherein the frequency is referred to as the welding frequency. In FIG. 2, the normal force is referred to with a force arrow F. Furthermore, double arrows 30 in FIG. 2 illustrate the welding amplitude and/or the welding frequency. An increase in the normal force and an increase in the frequency and/or the amplitude of the vibration lead to an increase in the amount of energy supplied.

In the case of sandwich composite components, especially sandwich composite components having a thermoplastic foam core, there is generally the risk that too high a normal force during friction welding will damage the layer composite 10. If the input or supplied energy is too high, the cover layer 16 may be melted. As a result, the joining element 28 can penetrate the layer composite 10 in an uncontrolled manner and damage it. This failure pattern can also materialize as a result of a counterforce which acts on the layer composite 10 and opposes the normal force being too low and the loaded core layer 12 collapsing. A further failure pattern is undesired marks resulting on the visible side 24. Such a mark is to be understood, for example, to be an undesired shine or undesired deformation on the visible side 24 and in particular on the surface of the decorative layer 22, wherein such a mark can also be caused by excessive normal force.

However, the connection of the joining element 28 to the layer composite 10 by friction welding is desirable, since the joining element 28 can be connected to the layer composite 10 in this way in a particularly time- and cost-effective manner, such that a cost-effective production of the vehicle can be achieved overall.

In order to connect the joining element 28 to the layer composite 10 by means of friction welding and thereby avoid undesired damage to the layer composite 10, provision is made, for example, as shown in FIG. 2, for the core layer 12 to have a higher density in at least one partial region 32 than in second partial regions 34 which are adjacent to the first partial region 32, wherein the joining element 28 is connected to the cover layer 16 in the first partial region 32 by means of friction welding. This higher density in the first partial region 32 compared to the respective second partial region 34 is produced, for example, by pressing the layer composite 10, in particular the core layer 12, more strongly in the first partial region 32 than in the second partial regions 34 during the previously described pressing. As a result of this locally stronger pressing, the core layer 12 has a higher density in the first partial region 32 than in the second partial regions 34, such that the core layer 12 has an increased compressive rigidity and compressive strength in the first partial region 32 compared to the second partial regions 34. The risk of the core layer 12 collapsing during friction welding can thus be kept particularly low. The necessary rigidity/counterforce of the foam can be generated not only by a local pressing of the foam layer, but also by a full-surface pressing. For this purpose, a density increase of the foam takes place over the entire component thickness. It has been proven to be expedient, for example, to press a foam core or core layer 12 with an original thickness of 3 mm and a density of 65 kg/m³ to approx. 2 mm. This stronger cross-component pressing also helps to consolidate the cover layers.

As an alternative or in addition to the locally stronger pressing, it is conceivable, for example, to produce the core layer 12 by means of an extrusion method and to vary the extrusion method in such a way that the core layer 12 has a higher density in the first partial region 32 than in the second partial regions 34. Furthermore, it is conceivable to separate one part from the core layer 12, after its production, in the first partial region 32, as a result of which a recess is formed in the first partial region 32. A foam body is then inserted into this recess, the foam body then being arranged in the first partial region 32. Here, the foam body has a higher density than the second partial regions 34. The joining element 28 is preferably produced by injection molding, i.e., as an injection-molded component, such that the joining element 28 can be produced in a particularly time- and cost-effective manner.

As a result of the locally stronger or higher pressing of the layer composite 10 which is shown on the left-hand side in relation to the image plane of FIG. 2, a counterpressure of the material of the core layer 12, the counterpressure opposing the normal force, can be increased since the core layer 12 has a higher compressive strength and compressive rigidity in the first partial region 32 compared to the second partial regions 34. The increase in the mechanical pressure properties of the thermoplastic foam core is due to the fact that pressing takes place, for example, in the hot state during the production of the component. In this case, the foam core is heated at least almost to the melting temperature of the thermoplastic matrix of the cover layers 14 and 16. At this temperature, which is, for example, 160 degrees Celsius to 250 degrees Celsius, the PET foam core can be compressed without cell walls of the foam core breaking or melting. The thus plastically compressed foam structure can absorb higher forces by the material compression, as a result of which the pressure properties are increased locally. This allows friction welding at a fairly high normal force, which is represented by the length of the force arrow F.

On the right-hand side of FIG. 2, a further option to avoid undesired damage to the layer composite 10 during friction welding is illustrated. The energy to be input for melting respective bonding surfaces with only a very low normal force is achieved by increasing the welding amplitude and/or welding frequency. Here, the welding amplitude is preferably at least substantially 1 millimeter. By increasing the welding amplitude and/or welding frequency, the normal force can be kept low such that the risk of the layer composite 10 collapsing can be kept particularly low.

1.-8. (canceled)

9. A composite component for a vehicle, comprising:
a core layer, wherein the core layer is a thermoplastic plastic foam; and
a cover layer, wherein the cover layer is connected to the core layer and wherein the cover layer is a fiber-reinforced plastic;
wherein the core layer has a higher density in a first region than in a second region and wherein the cover layer is connected at a position of the first region of the higher density of the core layer to a plastic joining element by friction welding;
wherein the fiber-reinforced plastic of the cover layer is a thermoplastic;
wherein the thermoplastic plastic foam of the core layer is polyethylene terephthalate.

10. The composite component for a vehicle according to claim 9, wherein the thermoplastic of the cover layer is polypropylene.

11. The composite component for a vehicle according to claim 9, wherein the core layer has a higher melting point than the cover layer.

12. The composite component for a vehicle according to claim 9, wherein the friction welding is carried out with a welding amplitude of 1 millimeter.

13. The composite component for a vehicle according to claim 10, wherein a temperature of the friction welding is in a range from 160 degrees Celsius to 250 degrees Celsius.

14. A method for production of a composite component of a vehicle, wherein the composite component includes:
a core layer, wherein the core layer is a thermoplastic plastic foam; and
a cover layer, wherein the cover layer is connected to the core layer and wherein the cover layer is a fiber-reinforced plastic;
wherein the core layer has a higher density in a first region than in a second region;
wherein the fiber-reinforced plastic of the cover layer is a thermoplastic;
wherein the thermoplastic plastic foam of the core layer is polyethylene terephthalate;
and comprising the step of:
connecting the cover layer at a position of the first region of the higher density of the core layer to a plastic joining element by friction welding.

15. The method according to claim 14, wherein the thermoplastic of the cover layer is polypropylene.

16. The method according to claim 14, wherein the core layer has a higher melting point than the cover layer.

17. The method according to claim 14, wherein the friction welding is carried out with a welding amplitude of 1 millimeter.

18. The method according to claim 15, wherein a temperature of the friction welding is in a range from 160 degrees Celsius to 250 degrees Celsius.
